(19) United States
(12) Patent Application Publication
(10) Pub. No.: US 2006/0057335 A1
(43) Pub. Date: Mar. 16, 2006

(54) Molded fiber panel having reduced surface fiber readout and method of molding thereof

(76) Inventors: Chen-Shih Wang, Troy, MI (US); Stanley A. Iobst, Troy, MI (US)

Correspondence Address: KATHRYN A MARRA;General Motors Corporation, Mail Code 482-C23-B21, P.O. Box 300, Detroit, MI, 48265-3000, US

(21) Appl. No.: 10/940,538

(22) Filed: Sep. 14, 2004

(51) Int. Cl. G11B 5/64; B32B 7/02

(52) U.S. Cl. 428/141; 428/218

(57) ABSTRACT

A molded fiber panel is disclosed having a fibrous material with a core and an outer surface, a relatively low density filler material disposed at the core, and a relatively high density filler material disposed at the outer surface. The outer surface has an as-molded surface roughness average of equal to or less than about 2 micro-meters.

### BACKGROUND OF THE INVENTION

The present disclosure relates generally to a molded fiber panel having reduced surface fiber readout and a method of molding thereof.

Liquid molded structural composites have been used for automotive cosmetic panel applications on a limited scale due to a surface appearance condition called fiber readout, which results from resin shrinkage during curing and cooling of the molded parts. To reduce resin shrinkage, methods such as incorporating fillers and low profile additives, and selecting resins with low cure shrinkage and low cure temperature, have all been suggested. These methods, however, typically do not reduce fiber readout to an acceptable level due to certain practical limitations. As a result, additional methods have been developed using a resin-rich surface layer to mask the fiber readout. One such method uses a surfacing veil placed on top of the fiber preform prior to molding the part. This method, however, has a limited success rate owing to its effectiveness for parts using high cost, small tow fibers at relatively low fiber volume fractions. Other methods first apply a B-staged resin film or a resin gel-coat onto the tool surface by a hand lay-up, brushing, or spraying process. The fiber preform is then charged into the molding tool for resin infiltration and curing. The cycle time of molding with resin films or gel-coats is generally on the order of hours, making these methods economically feasible only for production volumes lower than a few hundred parts a year.

To further minimize fiber readout, attempts have been made to keep the show surfaces of the parts in close contact with the mold tool surfaces during the entire molding cycle. One example of such a method places a piece of rubber sheet between the backside of the part and the tool surface, which is compressed by the molding pressure when the tool is first closed and pressurized. Following the curing stage, the compressed rubber expands into the free space created by the shrinking resins, thereby constantly exposing the part to the mold cavity pressure. However, this method is also typically feasible only for low volume production due to the limited rubber durability and consistency, and the presence of the rubber sheet also effects the heat flow from the press to the backside of the part, resulting in uneven heating and a longer cycle time.

Accordingly, there is a need in the art of molded fiber panels and methods of molding thereof that overcomes these drawbacks.

### BRIEF DESCRIPTION OF THE INVENTION

Embodiments of the invention disclose a molded fiber panel having a fibrous material with a core and an outer surface, a relatively low density filler material disposed at the core, and a relatively high density filler material disposed at the outer surface. The outer surface has an as-molded surface roughness average of equal to or less than about 2 micro-meters.

Other embodiments of the invention disclose a method of molding a fiber panel. A first filler material is applied to a fiber material to produce an impregnated fiber material. The impregnated material is preformed and partially cured to produce a gelled fiber preform. The preform is molded and a second filler material is applied to produce a molded form. The molded form is cured to produce an as-molded panel. The method produces an as-molded panel having an outer surface with an as-molded surface roughness average of equal to or less than about 2 micro-meters.

Further embodiments of the invention disclose the aforementioned molded fiber panel made by the aforementioned method.

### BRIEF DESCRIPTION OF THE DRAWINGS

Referring to the exemplary drawings wherein like elements are numbered alike in the accompanying Figures:

FIG. 1 depicts an exemplary method in block diagram form in accordance with embodiments of the invention;

FIG. 2 depicts an exemplary fiber material for use in embodiments of the invention;

FIG. 3 depicts a section view of the fiber material of FIG. 2; and

FIGS. 4 and 5 depict exemplary artistic renditions of optical readouts of surface contours for use in analyzing embodiments of the invention.

### DETAILED DESCRIPTION OF THE INVENTION

Embodiments of the invention provide a method for reducing the fiber readout on liquid molded structural composite surfaces that may be used for automobile panels, as well as for other parts desiring a cosmetically appealing appearance. By preforming a resin impregnated fiber mat and only partially curing it, the partially cured preform may then be molded and fully cured with a surfacing resin to form the final part (panel) having reduced fiber readout. While embodiments described herein may depict glass as an exemplary fiber mat, it will be appreciated that the disclosed invention is also applicable to other fiber mat materials, such as cotton, polyester, carbon or other suitable materials, for example.

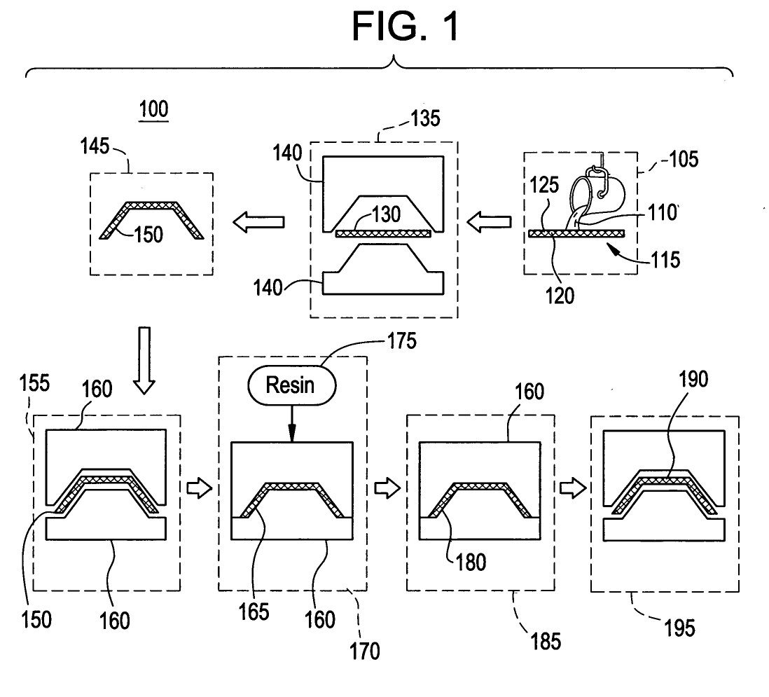

FIG. 1 is an exemplary embodiment of a method 100 of molding a fiber panel that may be used as an automotive panel desiring a cosmetically appealing outer surface. At 105, a first filler material 110 is applied to a fiber material 115 having a core 120 and an outer surface 125, thereby producing an impregnated fiber material 130. At 135, the impregnated fiber material 130 is shaped and partially cured by tool 140 to produce a gelled fiber preform 150. At 145 and 155, the preform 150 is transferred into tool 160. At 170, tool 160 is closed and a second filler material 175 is applied to produce a molded form 165, via injection molding or other suitable means, and a surfaced molded form 180. At 185, the surfaced molded form 180 is cured in tool 160, thereby producing an as-molded panel 190 that is demolded at 195. In an embodiment, the as-molded panel 190 has an outer surface 125 with a surface roughness average (Ra) of equal to or less than about 2 micro-meters, as may be measured via a Wyko NT 3300 Three Dimensional Optical Profiling System (available from manufacturer Veeco Instruments, Inc.). As used herein, the term as-molded panel means a panel as received from the tool 160 at the demolding 195 absent any secondary machining, sanding, polishing or addition of further fillers. In another embodiment, the as-molded panel 190 has an outer surface 125 with a surface roughness average (Ra) of equal to or less than about 1 micro-meter.

In a first exemplary embodiment resulting in an as-molded surface Ra of about 0.8 micro-meters, the fiber material 115 was a three-ply arrangement of Rovcloth 2454 glass fabric (available from manufacturer Fiber Glass Industries) having an F2/30 surfacing veil (available from manufacture Owens Corning), the first filler material 110 was a vinyl ester resin (Arotech Q6055 available from Ashland Specialty Chemical) having about 15 weight % low profile additives (LPA) (Epoxalloy 2110 available from Ashland Specialty Chemical) and about 60 weight % Calcium Carbonate (CaCO₃) (Camel-Fil available from manufacturer Imerys), and second filler material 175 was a vinyl ester resin having about 0 weight % LPA and about 60 weight % CaCO₃. The preforming 135 was performed at room temperature (about 20 degrees Celsius, deg-C) at about 2.4 MPa (Mega-Pascals) in tool 140 for about 40 minutes, and the molding 170 and curing 185 were performed at about 70 deg-C at about 0.7 MPa constant pressure for about 20 minutes.

While exemplary embodiments may be described using a specific fiber material and specific resin compositions, the disclosed invention is not so limited. For example, in a second exemplary embodiment resulting in an as-molded surface Ra of about 0.9 micro-meters, the fiber material 115 was a three-ply arrangement of 2454 glass fabric absent a surfacing veil, the first filler material was a vinyl ester resin having about 10 weight % LPA and about 60 weight % CaCO₃, and the second filler material was a vinyl ester resin having about 10 weight % LPA and about 60 weight % CaCO₃. In a third exemplary embodiment resulting in an as-molded surface Ra of about 2.0 micro-meters, the fiber material 115 was a three-ply arrangement of 2454 glass fabric absent a surfacing veil, the first filler material was a vinyl ester resin having about 0 weight % LPA and about 60 weight % CaCO₃, and the second filler material was a vinyl ester resin having about 0 weight % LPA and about 30 weight % CaCO₃.

While it may be known to use resins with low profile additives (LPAs) in an effort to reduce the surface profile of an as-molded panel, the aforementioned first exemplary embodiment demonstrates that a surface Ra of equal to or less than about 1 micro-meter is possible using a second filler material 175 having about 0 weight % LPA. More significantly, embodiments of the invention may use filler materials 110 and 175 that are different. By using filler material 110 having a lower density than filler material 175, relatively speaking, a lighter weight appearance panel may be produced. While attempts have been made to produce light weight appearance panels using bubble fillers, for example, such attempts have resulted in limited success since the presence of bubble fillers on the panel surface may significantly reduce the surface quality of the as-made panel. Other advantages to using different materials for fillers 110 and 175 relate to the added freedom of tailoring filler material viscosity and curing kinetics to better adjust and/or control the panel formability and process cycle time. As the aforementioned exemplary embodiments have demonstrated, first and second filler materials 110, 175, may be different, thereby enabling, relatively speaking, first filler material 110 to have a lower density than second filler material 175. That is, first filler material 110 may be a relatively low density material and second filler material may be a relatively high density material, with respect to each other. Thus, in an embodiment employing first and second filler materials 110, 175 having different densities, it has been observed that the resulting as-molded panel 190 has a variable density from the core 120 to the outer surface 125, with the outer surface 125 being of greater density, thereby resulting in a light weight part. In an alternative embodiment, first filler material 110 may include a bubble filler material made from glass or ceramic microspheres, or microparticles generally, which may be subsequently masked by the introduction of filler material 175.

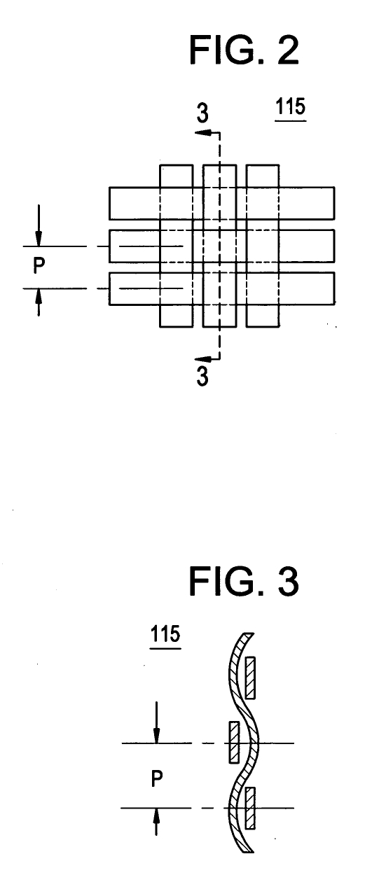

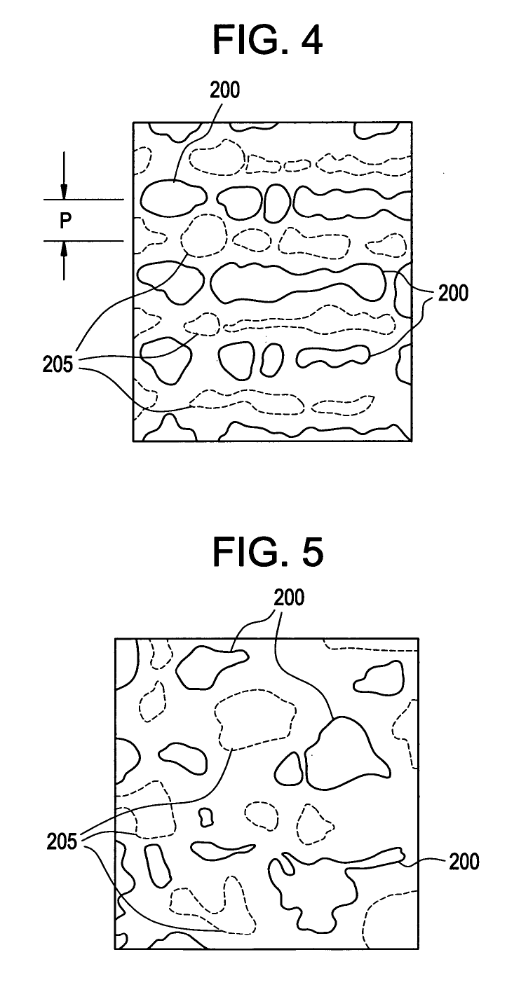

In alternative exemplary embodiments, fiber material 115 may be composed of continuous glass fibers, non-continuous glass fibers, random glass fibers, or a glass fabric. Referring now to FIGS. 2 and 3, a glass fabric fiber material 115 is depicted having a weave pattern with a weave periodicity P of equal to or less than about 5 millimeters. FIG. 3 depicts a section cut through the fabric of FIG. 2. By employing exemplary embodiments of the invention as disclosed herein, it has been demonstrated that a resulting as-molded panel 190 may have an outer surface 125 that is absent a visible weave periodicity P, which may be seen by now referring to FIGS. 4 and 5. Both embodiments of FIGS. 4 and 5 were molded with 3 plies of 2454 glass fabric. FIGS. 4 and 5 each represent an artistic rendition of a surface contour from an original color plot of an as-molded panel 190, where solid lines 200 illustrate “peak” islands, and dashed lines 205 illustrate “valley” islands, at the outer surface 125 of each respective panel 190. FIG. 4 illustrates surface contours of an as-molded panel not employing embodiments of the invention, and FIG. 5 illustrates surface contours of as-molded panel 190 employing embodiments of the invention. For purposes of demonstration, FIG. 4 is depicted having peaks and valleys ranging from +33 to −63 micro-meters (a surface Ra of about 7 micro-meters), and FIG. 5 is depicted having peaks and valleys ranging from +4 to −4 micro-meters (a surface Ra of about 0.8 micro-meters), indicating a significantly smoother surface with panels 190 employing embodiments of the invention. As can be seen, the peaks 200 and valleys 205 illustrated in FIG. 4 have a weave periodicity P, while the peaks 200 and valleys 205 illustrated in FIG. 5 are absent a weave periodicity P and are substantially random in appearance. The surface contours illustrated in FIGS. 4 and 5 were generated using the aforementioned Wyko NT 3300 Three Dimensional Optical Profiling System.

Surface roughness average (Ra) and weave periodicity P on the outer surface 125 of the as-molded panel 190, are indicators of the fiber readout present at the outer surface 125. Thus, by employing embodiments of the invention, the fiber readout at the outer surface 125 of the as-molded panel 190 may be reduced.

Method 100 that includes the applying 105, preforming and partial curing 135, transferring 145, 155, molding 170, curing 185, and demolding 195 operations, collectively defines a molding cycle time, and by employing embodiments of the invention, it is contemplated that this molding cycle time may be equal to or significantly less than about one hour, especially where the partial curing 135 operation is performed at an elevated temperature above room temperature. It is further contemplated that the cycle time may be shortened to 10 to 15 minutes by manipulating temperature and cure kinetics. Where method 100 is sequential, there exists the freedom to adjust temperature and cure kinetics at the performing 135, molding 170, and curing 185 stages, thereby enabling a reduction in molding cycle time.

By applying an embodiment of method 100, it is contemplated that a molded fiber panel 190 will result having a fibrous material 115 having a core 120 and an outer surface 125, a relatively low density filler material 110 disposed at the core 120, and a relatively high density filler material 175 disposed at the outer surface 125, where the outer surface 125 has an as-molded surface roughness average (Ra) of equal to or less than about 2 micro-meters in one embodiment, and equal to or less than about 1 micro-meter in another embodiment. As discussed previously, fibrous material 115 may include continuous glass fibers, non-continuous glass fibers, random glass fibers, or a glass fabric, the relatively low density filler material 110 may include a bubble filler material made from glass or ceramic microparticles, and the relatively high density filler material 175 may include a low profile additive of equal to or less than about 15 weight % in one embodiment, and equal to or less than about 10 weight % in another embodiment.

While embodiments of the invention have been described employing certain molding process parameters, such as temperature and pressure for example, it will be appreciated that useful molding process parameters may vary depending on the choice of resin and the size of the desired panel, and that the scope of the invention is not so limited to only those molding process parameters disclosed herein.

As disclosed, some embodiments of the invention may include some of the following advantages: a light weight panel having a relatively low density core and a relatively high density surface; an as-molded panel having an outer surface roughness average (Ra) equal to or less than about 1 micro-meter; an as-molded panel suitable for use as an automotive cosmetic panel; an as-molded panel suitable for use as an automotive Class-A composite panel; the availability of a liquid molding process having a molding cycle time equal to or significantly less than about one hour; a panel molding process absent the requirement of secondary surface finishing; and, reduced surface imperfections by reducing the use of low profile additives in the surface resin that tend to cause the surface imperfections by forming micro voids.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A molded fiber panel, comprising:
a fibrous material having a core and an outer surface;
a relatively low density filler material disposed at the core; and
a relatively high density filler material disposed at the outer surface, the outer surface having an as-molded surface roughness average of equal to or less than about 2 micro-meters.

2. The panel of claim 1, wherein the outer surface has an as-molded surface roughness average of equal to or less than about 1 micro-meter.

3. The panel of claim 1, wherein:
the fibrous material comprises glass fibers; and
the relatively high density filler material comprises a low profile additive of equal to or less than about 15 weight %.

4. The panel of claim 3, wherein:
the relatively low density filler material comprises a bubble filler material.

5. The panel of claim 4, wherein:
the bubble filler material comprises glass microparticles, ceramic microparticles, or any combination comprising at least one of the foregoing microparticles.

6. The panel of claim 3, wherein:
the relatively high density filler material comprises a low profile additive of equal to or less than about 10 weight %.

7. The panel of claim 3, wherein:
the glass fibers comprise continuous glass fibers, non-continuous glass fibers, random glass fibers, a glass fabric, or any combination comprising at least one of the foregoing.

8. The panel of claim 7, wherein:
the glass fibers comprise a glass fabric having a weave periodicity; and
the outer surface is absent a weave periodicity.

9. A method of molding a fiber panel, comprising:
applying a first filler material to a fiber material thereby producing an impregnated fiber material;
preforming and partially curing the impregnated material thereby producing a gelled fiber preform;
molding the preform and applying a second filler material to produce a molded form; and
curing the molded form, thereby producing an as-molded panel comprising an outer surface having an as-molded surface roughness average of equal to or less than about 2 micro-meters.

10. The method of claim 9, wherein the curing produces an as-molded panel comprising an outer surface having an as-molded surface roughness average of equal to or less than about 1 micro-meter.

11. The method of claim 9, wherein:
the applying a first filler material comprises applying a relatively low density filler material;
the applying a second filler material comprises applying a relatively high density filler material; and
the curing produces an as-molded panel having a variable density from a core to an outer surface of the panel.

12. The method of claim 11, wherein:
the applying a first filler material comprises applying a bubble filler material.

13. The method of claim 9, wherein:
the fiber material comprises continuous glass fibers, non-continuous glass fibers, random glass fibers, a glass fabric, or any combination comprising at least one of the foregoing.

14. The method of claim 9, wherein:
the applying a second filler material comprises applying a second filler material comprising a low profile additive of equal to or less than about 15 weight %.

15. The method of claim 14, wherein:
the applying a second filler material comprises applying a second filler material comprising a low profile additive of equal to or less than about 10 weight %.

16. The method of claim 9, further comprising:
applying a first filler material to a glass fiber fabric having a weave periodicity;
wherein the curing produces an as-molded panel having an outer surface absent a weave periodicity.

17. The method of claim 9, wherein:
the applying a first filler material, the preforming and partially curing, the molding, and the curing, collectively define a molding cycle time that is equal to or less than about one hour.

18. The method of claim 17, wherein:
the molding cycle time is equal to or less than about 15 minutes.

19. A molded fiber panel, comprising:
a fibrous material having a core and an outer surface;
a relatively low density filler material disposed at the core; and
a relatively high density filler material disposed at the outer surface, the outer surface having an as-molded surface roughness average of equal to or less than about 2 micro-meters;
made by a method, comprising:
applying the relatively low density filler material to a fibrous material thereby producing an impregnated fibrous material;
preforming and partially curing the impregnated material thereby producing a gelled fiber preform;
molding the preform and applying the relatively high density filler material to produce a molded form; and
curing the molded form, thereby producing the panel comprising an outer surface having an as-molded surface roughness average of equal to or less than about 2 micro-meters.
